(19) United States
(12) Patent Application Publication
(10) Pub. No.: US 2003/0172282 A1
(43) Pub. Date: Sep. 11, 2003

(54) Log-on processing

(75) Inventor: William Jiang, Green Brook, NJ (US)

Correspondence Address: Robert V. Wilder, Attorney at Law, 4235 Kingsburg Drive, Round Rock, TX, 78681, US

(73) Assignee: International Business Machines Corporation, Armonk, NY

(21) Appl. No.: 10/093,427

(22) Filed: Mar. 7, 2002

(51) Int. Cl. H04K 1/00

(52) U.S. Cl. 713/184

(57) ABSTRACT

An improved methodology and implementing system are provided in which a number of different user ID and password combinations are assigned to the user. Each combination is associated with a different service which may be requested by the user. When a user ID and password combination is uploaded from a terminal to a server, the server system compares the combination with a stored memory of associations to determine which of several possible services is being requested by the user. In one example, a server will respond to a first combination to enable normal processing of a money transaction at an ATM terminal, but will respond to a second combination to effect notification of authorities that a distress situation such as a robbery is occurring at the terminal.

### FIELD OF THE INVENTION

The present invention relates generally to information processing systems and more particularly to a method and apparatus for providing special service processing of log-on transactions.

### BACKGROUND OF THE INVENTION

The widespread use of network systems, including the Internet, the World Wide Web and private networks, has been responsible for facilitating the automatic management of many different kinds of financial resources and financial transactions. An automatic teller machine (ATM) which allows deposits and withdrawals of cash from accounts, can be found in many commercial establishments and have become very widely used by the public in withdrawing money as needed by a customer.

On a larger scale, banks and banking institutions also use networked communication systems to control and/or monitor financial transactions. In most systems, financial transactions are initiated when a user inputs a user identification (ID) and a unique user password. At that point, a verification is made by the financial institution of the user ID and the password and if both are valid, the transaction is enabled to continue and the user may designate an amount of money, for example, which the user wishes to withdraw. Unfortunately, in current systems, there is no way to determine if the withdrawal is being made by an unauthorized person, i.e. by one who has stolen the user ID and password from a customer, so long as the user ID and password are correct.

Further, many remote transaction terminals which contain cash are locked and unlocked through the use of entered user IDs and passwords. For example, a cashier in a commercial or financial establishment will only be enabled to gain access to a cash drawer by entering an authorized user ID and password. Unfortunately, if the cashier is being robbed and is forced to enter the correct inputs to gain access to the cash drawer, there is no way to sound an alarm or request other assistance without arousing the ire of the robber. In other words, if the robber sees that the transaction is no progressing smoothly with the entry of the correct information, the robber will become alarmed and take action to avoid being apprehended.

Thus there is a need for an improved system by which financial and other unlawful or inappropriate transactions may be identified as being initiated under stress, and requests for specific assistance services can be made in such cases without disclosing that such requests are in fact being made.

### SUMMARY OF THE INVENTION

An improved methodology and implementing system are provided in which a number of different user ID and password combinations are assigned to the user. Each combination is associated with a different service which may be requested by the user. When a user ID and password combination is uploaded from a terminal to a server, the server system compares the combination with a stored memory of associations to determine which of several possible services is being requested by the user. In one example, a server will respond to a first combination to enable normal processing of a money transaction at an ATM terminal, but will respond to a second combination to effect notification of authorities that a distress situation such as robbery is occurring at the terminal.

### BRIEF DESCRIPTION OF THE DRAWINGS

A better understanding of the present invention can be obtained when the following detailed description of a preferred embodiment is considered in conjunction with the following drawings, in which:

FIG. 1 is schematic drawing illustrating an exemplary system in which the present invention may be implemented;

FIG. 2 is an illustration of major components of a server computer which is used in an exemplary operational sequence of a methodology implemented in accordance with the present invention;

FIG. 3 is a flow chart illustrating an exemplary operational sequence in accordance with the present invention;

FIG. 4 a sequence diagram illustrating a message sequence used in accordance with the present invention; and

FIG. 5 is an illustration of a database maintained to identify services which may be requested by associated terminals.

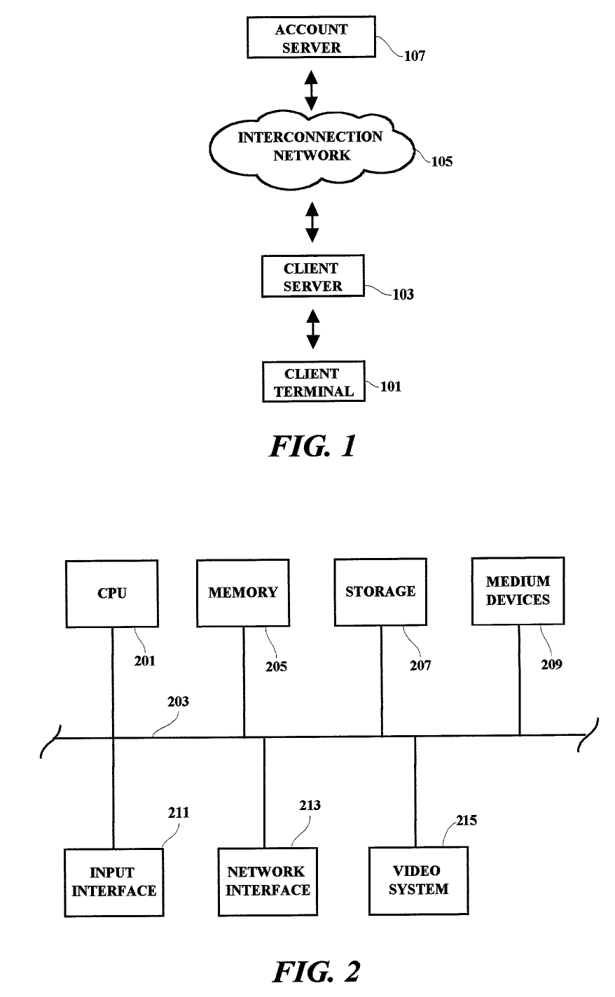

### DETAILED DESCRIPTION

The various methods discussed herein may be implemented, for example, within a server system which is accessed through a network connection, such as the Internet or a private connection. The example illustrated herein includes a banking server 107 which is accessed by a user terminal 101 or ATM. The user terminal, in the example, may communicate through a client server 103 such as a local bank server, and then through an interconnection network 105 to the main server system 107 of the bank accounts. The account or banking server 107 in the present example, is enabled to provide authentication as well as service functions.

As shown in FIG. 2, the account server 107 may include one or more CPUs 201 connected to a main system bus 203. The server further includes a memory system 205, a storage system 207 various medium devices 209, an input interface 211, a network interface 213 and one or more video systems 215, all connected to the main system bus 203. The server bus 203 is arranged to be connected to other networks and systems as may be appropriate depending upon the particular application.

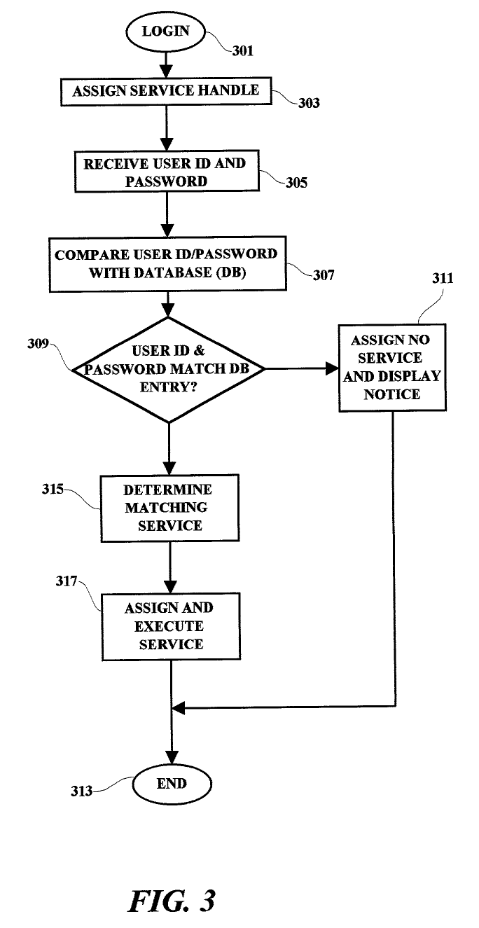

As shown in FIG. 3, when a user logs-on 301 to an ATM system, for example, the system may first assign a service handle 303 for the transaction and then receives 305 a user identification (UID) and a password (PW) which are input by the user. The assignment of the service handle is optional and may occur before or after validation of user access. The server then compares the UID/password combination with a client services database 307. If there is no matching service for the input UID/PW combination, then no service is assigned to the transaction 311 and an appropriate notice is displayed at the user terminal as the processing ends 313. In that case, an appropriate predetermined message may be caused to appear on the screen at the ATM or user terminal. If, however, there is a match for the received UID/PW 309, then the processing continues by making a determination 315 of the identity of the requested service. The selected service handle is then assigned to the transaction and executed as appropriate 317. For example, for a given UID/PW combination, a normal banking operation service may be requested and assigned to the transaction. However, if a user at an ATM is being forced to withdraw funds from the user's account for example, the user may input a different UID or PW which when matched to the server database would indicate that a robbery is taking place. In that instance, by pre-arrangement, the transaction screens may continue to run at the ATM so as not to alarm the robber while, at the same time, the service would notify appropriate authorities of the situation and request that immediate remedial action be taken. This may take the form of an email or audible message being sent. The banking server would know the exact location of the ATM and be able to include the exact location of the ATM in the notification to authorities. Following this processing and appropriate notification, the alarm processing would end 313.

It is noted that the exact action to be taken in response to a given UID/PW combination could be any pre-arranged action and it could vary depending upon the application. For example, in response to a predetermined alarm UID/PW combination, in addition to sending an alarm message out to authorities, a server may continue to process an apparent financial transaction by causing the appropriate screens to appear at the user ATM so that the robber is not alarmed. In that case, the screen presentations and subsequent input would not be acted upon but rather continued in order to keep the robber at the ATM until the authorities arrive. Alternatively, in that situation the server may effect the presentation of other “false” screens at the ATM terminal to keep the robber at the terminal until authorities arrive. For example, one “false” screen may indicate that “The system is currently experiencing a heavy demand causing unusual delays in transaction processing. We expect the system to return to normal shortly”.

Optionally, a non-textual acknowledgement notice can be sent from the server to the ATM screen indicating that the alarm condition has been detected and alarms have been sent to appropriate authorities. Such acknowledgement would be non-textual so as not to alarm a robber who may be viewing the display screen of the ATM. Such non-textual communication may take many forms including merely the appearance of a predetermined symbol at a predetermined location on the display screen so that although a customer knows what the appearance of the symbol means, it would not be known to a robber viewing the display screen.

In FIG. 4, there is illustrated a sequence diagram in which a user 401 logs-on to the system 403. If the UID/PW input cannot be validated, the processing assigns no service 405 and returns to the user. If there is a validation of the UID/PW combination, then the requested service 407 is assigned 405 and an appropriate message is returned to the user.

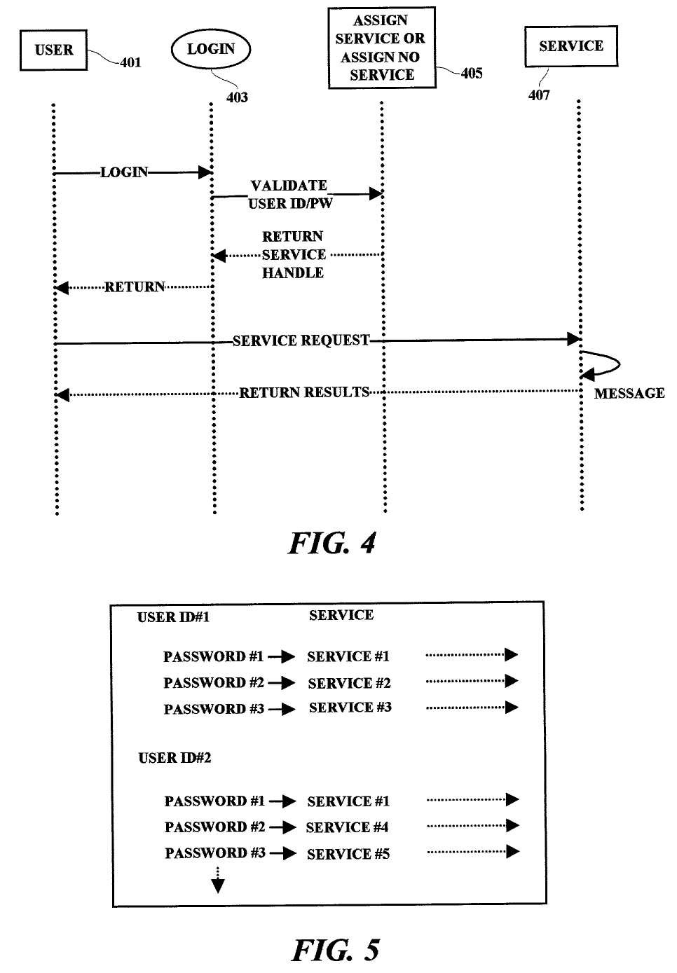

In FIG. 5, there is shown an exemplary database which may be maintained at the server site and used to match-up the UID/PW input combination with corresponding requested services. As illustrated, the requested services may be different for each user or type of terminal being serviced. Several exemplary services include, for example, notification to one or more various police agencies as well as requested notification to banking or server managers of various possible distress situations. In the exemplary situations, the entry of different UID/PW combinations at a display terminal is effective to accomplish predetermined actions initiated at a server site, such as the automatic sending of distress messages, which do not effect a display of the actions taken at the user terminal display. In some cases, messages displayed at the user terminal may actually be false messages in order, for example, to stall an ATM robbery until authorities arrive.

The method and apparatus of the present invention has been described in connection with a preferred embodiment as disclosed herein. The disclosed methodology may be implemented in hardware, software or a combination of both hardware and software. Further, a wide range of sequences, menus and screen designs may be implemented to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing access requests to a server for server processing services from a remote terminal, said method comprising:
receiving access request information from said remote terminal for accessing a selected processing service available to said remote terminal from said server;
comparing said access request information with a services database, said services database including user identification information and server services available for access by said user; and
enabling access to selected server services, said selected server services being determined by comparing said access request information with information contained in said services database, said method further including providing alarm condition notification to predetermined third parties in response to a predetermined form of said access request information for processing services.

2. The method as set forth in claim 1 wherein said access request information includes user identification (UID) specifically identifying a specific user.

3. The method as set forth in claim 2 wherein said access request information further includes password (PW) information specifically associated with said specific user.

4. The method as set forth in claim 3 wherein said services database includes UIDs and PWs for a plurality of said users.

5. The method as set forth in claim 4 wherein said alarm condition notification is provided in response to a detection of predetermined combinations of said UIDs and said PWs.

6. The method as set forth in claim 5 wherein said remote terminal includes a display screen, said alarm condition notification being provided without textual notice at said display screen that said alarm condition notification has been provided.

7. The method as set forth in claim 6 wherein an alarm condition acknowledgement notice that said alarm condition notification has been provided is communicated to said display screen in a non-textual format.

8. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective for processing service requests to a server from a remote terminal, said program signals being selectively operable to accomplish the steps of:
receiving access request information from said remote terminal for accessing a selected processing service available to said remote terminal from said server;
comparing said access request information with a services database, said services database including user identification information and server services available for access by said user; and
enabling access to selected server services, said selected server services being determined by comparing said access request information with information contained in said services database, said method further including providing alarm condition notification to predetermined third parties in response to a predetermined form of said access request information for processing services.

9. The medium as set forth in claim 8 wherein said access request information includes user identification (UID) specifically identifying a specific user.

10. The medium as set forth in claim 9 wherein said access request information further includes password (PW) information specifically associated with said specific user.

11. The medium as set forth in claim 10 wherein said services database includes UIDs and PWs for a plurality of said users.

12. The medium as set forth in claim 11 wherein said alarm condition notification is provided in response to a detection of predetermined combinations of said UIDs and said PWs.

13. The medium as set forth in claim 12 wherein said remote terminal includes a display screen, said alarm condition notification being provided without textual notice at said display screen that said alarm condition notification has been provided.

14. The medium as set forth in claim 13 wherein an alarm condition acknowledgement notice that said alarm condition notification has been provided is communicated to said display screen in a non-textual format.

15. A computer server for processing service requests from a remote terminal comprising:
a system bus;
a processing device coupled to said system bus;
memory means connected to said system bus, said memory means being arranged for saving and accessing a services database, said services database including user identification information and server services available for access by a remote terminal; and
means for receiving said service requests, said system being selectively operable for receiving access request information from said remote terminal for accessing a selected processing service available to said remote terminal from said server, and comparing said access request information with a services database, said services database including user identification information and server services available for access by said user, said server being further selectively operable for enabling access to selected server services, said selected server services being determined by comparing said access request information with information contained in said services database, said server being operable for providing alarm condition notification to predetermined third parties in response to a predetermined form of said access request information for processing services.
